(19) United States
(12) Patent Application Publication
(10) Pub. No.: US 2017/0070751 A1
(43) Pub. Date: Mar. 9, 2017

(54) IMAGE ENCODING APPARATUS AND METHOD, IMAGE DECODING APPARATUS AND METHOD, AND PROGRAMS THEREFOR

(71) Applicant: NIPPON TELEGRAPH AND TELEPHONE CORPORATION, Tokyo (JP)

(72) Inventors: Shinya SHIMIZU, Yokosuka-shi (JP); Shiori SUGIMOTO, Yokosuka-shi (JP)

(73) Assignee: NIPPON TELEGRAPH AND TELEPHONE CORPORATION, Tokyo (JP)

(21) Appl. No.: 15/122,551

(22) PCT Filed: Mar. 16, 2015
(86) PCT No.: PCT/JP2015/057631

§ 371 Date: Aug. 30, 2016

(30) Foreign Application Priority Data
Mar. 20, 2014 (JP) 2014-058902

(51) Int. Cl. H04N 19/597; H04N 19/172; H04N 19/11; H04N 19/159

(52) U.S. Cl. CPC H04N 19/597; H04N 19/159; H04N 19/172; H04N 19/11

(57) ABSTRACT

When multiview images are encoded, a first viewpoint-synthesized image for an encoding target region is generated by using a reference viewpoint image from a viewpoint other than that of the encoding target image and a reference depth map for the reference viewpoint image. A second viewpoint-synthesized image for reference pixels is generated by using the first viewpoint-synthesized image, where the reference pixels are a set of already-encoded pixels, which are referred to in intra prediction of the encoding target region. An intra predicted image for the encoding target region is generated by using a decoded image for the reference pixels and the second viewpoint-synthesized image.

### TECHNICAL FIELD

The present invention relates to an image encoding apparatus, an image decoding apparatus, an image encoding method, an image decoding method, an image encoding program, and an image decoding program, which are utilized to encode and decode multiview images.

Priority is claimed on Japanese Patent Application No. 2014-058902, filed Mar. 20, 2014, the contents of which are incorporated herein by reference.

### BACKGROUND ART

Conventionally, multiview images are known, which are formed by a plurality of images obtained by a plurality of cameras, where the same object and background thereof are imaged by the cameras. Video images obtained by a plurality of cameras is called “multiview (or multi-viewpoint) video images” (or “multiview videos”).

In the following explanation, an image (or video) obtained by one camera is called a “two-dimensional image (or video)”, and a set of two-dimensional images (or two-dimensional videos) in which the same object and background thereof are photographed by a plurality of cameras having different positions and directions (where the position and direction of each camera is called a “viewpoint” below) is called “multiview images (or multiview videos)”.

There is a strong temporal correlation in the two-dimensional video and the level of encoding efficiency therefor can be improved by utilizing this correlation. For the multiview images (or video), when the individual cameras are synchronized with each other, the frames (images) corresponding to the same time in the videos obtained by the individual cameras capture the object and background thereof in entirely the same state from different positions, so that there is a strong correlation between the cameras (i.e., between different two-dimensional images obtained at the same time). The level of encoding efficiency for the multiview images or videos can be improved using this correlation.

Here, conventional techniques relating to the encoding of a two-dimensional video will be shown.

In many known methods of encoding a two-dimensional video, such as H. 264, H. 265, MPEG-2, MPEG-4 (which are international encoding standards), and the like, highly efficient encoding is performed by means of motion-compensated prediction, orthogonal transformation, quantization, entropy encoding, or the like. For example, in H. 265, it is possible to perform encoding using temporal correlation between an encoding target frame and a plurality of past or future frames.

For example, Non-Patent Document 1 discloses detailed motion compensation prediction techniques used in H. 265. Below, general explanations of the motion compensation prediction techniques used in H. 265 will be shown.

In the motion compensation used in H. 265, an encoding target frame is divided into blocks of any size, and each block can have an individual motion vector and an individual reference frame. When each block uses an individual motion vector, highly accurate prediction is implemented by compensating a specific motion of each object. In addition, when each block uses an individual reference frame, highly accurate prediction is also implemented in consideration of occlusion generated according to a temporal change.

Next, conventional encoding methods for multiview images or multiview videos will be explained.

In comparison with the encoding method for multiview image, in the encoding method for multiview videos, there simultaneously exists a temporal correlation in addition to the correlation between the cameras. However, in either case, the inter-camera correlation can be utilized by an identical method. Therefore, a method applied to the encoding of multiview videos will be explained below.

Since the encoding of multiview videos utilizes the inter-camera correlation, a known method highly efficiently encodes multiview videos by means of “disparity-compensated prediction” which applies motion-compensated prediction to images obtained at the same time by different cameras. Here, disparity is the difference between positions at which an identical part on an object exists on the image planes of cameras which are disposed at different positions.

FIG. 7 is a schematic view showing the concept of disparity generated between cameras. The schematic view of FIG. 7 shows a state in which an observer looks down on image planes of cameras, whose optical axes are parallel to each other, from the upper side thereof. Generally, positions to which an identical point on an object is projected, on image planes of different cameras, are called “corresponding points”.

In the disparity-compensated prediction, based on the above corresponding relationship, each pixel value of an encoding target frame is predicted using a reference frame, and the relevant prediction residual and disparity information which indicates the corresponding relationship are encoded. Since disparity varies for a target pair of cameras or relevant positions, it is necessary to encode the disparity information for each region to which the disparity-compensated prediction is applied.

In a multiview video encoding method defined in H. 265, a vector which represents the disparity information is encoded for each block to which the disparity-compensated prediction is applied.

By using camera parameters and the Epipolar geometry constraint, the above corresponding relationship obtained by the disparity information can be represented by a one-dimensional quantity which represents a three-dimensional position of an object, without using a two-dimensional vector.

Although the information which represents the three-dimensional position of an object may be represented in various manners, a distance from a camera (as a standard) to the object or coordinate values on an axis which is not parallel to the image plane of the camera is employed generally. Here, instead of the distance, a reciprocal thereof may be employed. In addition, since the reciprocal of the distance functions as information in proportion to disparity, two cameras may be prepared as standards, and the amount of disparity between images obtained by these cameras may be employed as the relevant representation.

There is no substantial difference between such representations. Therefore, the representations will not be distinguished with each other below and the information which represents the three-dimensional position is generally called a “depth”.

FIG. 8 is a schematic view showing the concept of the Epipolar geometry constraint. In accordance with the Epipolar geometry constraint, when a point in an image of a camera corresponds to a point in an image of another camera, the point of another camera is constrained on a straight line called an “Epipolar line”. In such a case, if a depth is obtained for the relevant pixel, the corresponding point can be determined on the Epipolar line in a one-to-one correspondence manner.

For example, as shown in FIG. 8, a point of the imaged object, which is projected onto the position “m” in a first camera image, is projected (in a second camera image) onto (i) the position m′ on the Epipolar line when the corresponding point of the imaged object in the actual space is the position M′, and (ii) the position m″ on the Epipolar line when the corresponding point of the imaged object in the actual space is the position M″.

Non-Patent Document 2 utilizes such characteristics, where in accordance with three-dimensional information about each object, which is obtained by a depth map (i.e., distance image) for a reference frame, a synthesized image for an encoding target frame is generated from the reference frame. This synthesized image is utilized as a candidate for a predicted image of a relevant region, thereby highly accurate prediction is performed and efficient multiview video encoding is implemented.

The above synthesized image generated based on the depth is called a “viewpoint-synthesized image”, a “viewpoint-interpolated image”, or a “disparity-compensated image”.

Additionally, in Non-Patent Document 3, even when a viewpoint-synthesized image having a sufficient image quality cannot be generated (e.g., when the depth map has a relatively low accuracy or when the same point in real space has slightly different image signals at different viewpoints), spatial or temporal predictive encoding of a prediction residual for a predicted image which is the above viewpoint-synthesized image is performed so as to reduce the amount of the prediction residual to be encoded and thus to implement effective multiview video encoding.

According to the method of Non-Patent Document 3, the viewpoint-synthesized image generated by utilizing the three-dimensional information (obtained from a depth map) about an object is used as a predicted image, and spatial or temporal predictive encoding of a corresponding prediction residual is performed. Therefore, even when the quantity of the viewpoint-synthesized image is not high, robust and efficient encoding can be implemented.

### PRIOR ART DOCUMENT

### Non-Patent Document

Non-Patent Document 1: ITU-T Recommendation H.265 (April 2013), “High efficiency video coding”, April, 2013.
Non-Patent Document 2: S. Shimizu, H. Kimata, and Y. Ohtani, “Adaptive appearance compensated view synthesis prediction for Multiview Video Coding”, Image Processing (ICIP), 2009 16th IEEE International Conference, pp. 2949-2952, 7-10 Nov. 2009.
Non-Patent Document 3: S. Shimizu and H. Kimata, “MVC view synthesis residual prediction”, JVT Input Contribution, JVT-X084, June, 2007.

### DISCLOSURE OF INVENTION

### Problem to be Solved by the Invention

However, in the methods of Non-Patent Documents 2 and 3, regardless of whether or not a viewpoint-synthesized image is utilized, the viewpoint-synthesized image should be generated and stored for the entire image, which increases a processing load or memory consumption.

The viewpoint-synthesized image may be generated for part of the image by estimating a depth map for a region which needs the viewpoint-synthesized image. However, when the residual prediction is performed, the viewpoint-synthesized image must be generated, not only for a target region of the prediction, but also for a set of reference pixels utilized in the residual prediction. Therefore, the above-described problem as an increase in the processing load or memory consumption still exists.

In particular, if the prediction residual for the viewpoint-synthesized image as the predicted image is spatially predicted, a set of pixels to be referred to is arranged in one line or column adjacent to the target region to be predicted, and thus disparity-compensated prediction should be performed with a block size which is generally not employed. Accordingly, there occurs a problem that mounting or memory access of the relevant apparatus becomes complex.

In light of the above circumstances, an object of the present invention is to provide an image encoding apparatus, an image decoding apparatus, an image encoding method, an image decoding method, an image encoding program, and an image decoding program, by which when a viewpoint-synthesized image is utilized as a predicted image, spatial predictive encoding of a corresponding prediction residual can be performed while preventing the relevant processing or memory access from becoming complex.

### Means for Solving the Problem

The present invention provides an image encoding apparatus that encodes multiview images from different viewpoints, where each of encoding target regions obtained by dividing an encoding target image is encoded while an already-encoded reference viewpoint image from a viewpoint other than that of the encoding target image and a reference depth map for an object imaged in the reference viewpoint image are used to predict an image between different viewpoints, the apparatus comprising:

an encoding target region viewpoint-synthesized image generation device that generates a first viewpoint-synthesized image for the encoding target region by using the reference viewpoint image and the reference depth map;

a reference pixel determination device that determines a set of already-encoded pixels, which are referred to in intra prediction of the encoding target region, to be reference pixels;

a reference pixel viewpoint-synthesized image generation device that generates a second viewpoint-synthesized image for the reference pixels by using the first viewpoint-synthesized image; and

an intra predicted image generation device that generates an intra predicted image for the encoding target region by using a decoded image for the reference pixels and the second viewpoint-synthesized image.

Typically, the intra predicted image generation device generates:

a difference intra predicted image which is an intra predicted image for a difference image between the encoding target image of the encoding target region and the first viewpoint-synthesized image; and

the intra predicted image for the encoding target region by using the difference intra predicted image and the first viewpoint-synthesized image.

In a preferable example, the apparatus further comprises:

an intra prediction method setting device that sets an intra prediction method applied to the encoding target region,

wherein the reference pixel determination device determines a set of already-encoded pixels, which are referred to when the intra prediction method is used, to be the reference pixels; and

the intra predicted image generation device generates the intra predicted image based on the intra prediction method.

In this case, the reference pixel viewpoint-synthesized image generation device may generate the second viewpoint-synthesized image based on the intra prediction method.

In another preferable example, the reference pixel viewpoint-synthesized image generation device generates the second viewpoint-synthesized image by performing an extrapolation from the first viewpoint-synthesized image.

In this case, the reference pixel viewpoint-synthesized image generation device may generate the second viewpoint-synthesized image by using a set of pixels of the first viewpoint-synthesized image, which corresponds to a set of pixels which belong to the encoding target region and are adjacent to pixels outside the encoding target region.

The present invention also provides an image decoding apparatus that decodes a decoding target image from encoded data for multiview images from different viewpoints, where each of decoding target regions obtained by dividing the decoding target image is decoded while an already-decoded reference viewpoint image from a viewpoint other than that of the decoding target image and a reference depth map for an object imaged in the reference viewpoint image are used to predict an image between different viewpoints, the apparatus comprising:

a decoding target region viewpoint-synthesized image generation device that generates a first viewpoint-synthesized image for the decoding target region by using the reference viewpoint image and the reference depth map;

a reference pixel determination device that determines a set of already-decoded pixels, which are referred to in intra prediction of the decoding target region, to be reference pixels;

a reference pixel viewpoint-synthesized image generation device that generates a second viewpoint-synthesized image for the reference pixels by using the first viewpoint-synthesized image; and

an intra predicted image generation device that generates an intra predicted image for the decoding target region by using a decoded image for the reference pixels and the second viewpoint-synthesized image.

Typically, the intra predicted image generation device generates:

a difference intra predicted image which is an intra predicted image for a difference image between the decoding target image of the decoding target region and the first viewpoint-synthesized image; and

the intra predicted image for the encoding target region by using the difference intra predicted image and the first viewpoint-synthesized image.

In a preferable example, the apparatus further comprises:

an intra prediction method setting device that sets an intra prediction method applied to the decoding target region;

the reference pixel determination device determines a set of already-decoded pixels, which are referred to when the intra prediction method is used, to be the reference pixels; and

the intra predicted image generation device generates the intra predicted image based on the intra prediction method.

In this case, the reference pixel viewpoint-synthesized image generation device may generate the second viewpoint-synthesized image based on the intra prediction method.

In another preferable example, the reference pixel viewpoint-synthesized image generation device generates the second viewpoint-synthesized image by performing an extrapolation from the first viewpoint-synthesized image.

In this case, the reference pixel viewpoint-synthesized image generation device may generate the second viewpoint-synthesized image by using a set of pixels of the first viewpoint-synthesized image, which corresponds to a set of pixels which belong to the decoding target region and are adjacent to pixels outside the decoding target region.

The present invention also provides an image encoding method that encodes multiview images from different viewpoints, where each of encoding target regions obtained by dividing an encoding target image is encoded while an already-encoded reference viewpoint image from a viewpoint other than that of the encoding target image and a reference depth map for an object imaged in the reference viewpoint image are used to predict an image between different viewpoints, the method comprising:

an encoding target region viewpoint-synthesized image generation step that generates a first viewpoint-synthesized image for the encoding target region by using the reference viewpoint image and the reference depth map;

a reference pixel determination step that determines a set of already-encoded pixels, which are referred to in intra prediction of the encoding target region, to be reference pixels;

a reference pixel viewpoint-synthesized image generation step that generates a second viewpoint-synthesized image for the reference pixels by using the first viewpoint-synthesized image; and

an intra predicted image generation step that generates an intra predicted image for the encoding target region by using a decoded image for the reference pixels and the second viewpoint-synthesized image.

The present invention also provides an image decoding method that decodes a decoding target image from encoded data for multiview images from different viewpoints, where each of decoding target regions obtained by dividing the decoding target image is decoded while an already-decoded reference viewpoint image from a viewpoint other than that of the decoding target image and a reference depth map for an object imaged in the reference viewpoint image are used to predict an image between different viewpoints, the method comprising:

a decoding target region viewpoint-synthesized image generation step that generates a first viewpoint-synthesized image for the decoding target region by using the reference viewpoint image and the reference depth map;

a reference pixel determination step that determines a set of already-decoded pixels, which are referred to in intra prediction of the decoding target region, to be reference pixels;

a reference pixel viewpoint-synthesized image generation step that generates a second viewpoint-synthesized image for the reference pixels by using the first viewpoint-synthesized image; and

an intra predicted image generation step that generates an intra predicted image for the decoding target region by using a decoded image for the reference pixels and the second viewpoint-synthesized image.

The present invention also provides an image encoding program utilized to make a computer execute the above image encoding method.

The present invention also provides an image decoding program utilized to make a computer execute the above image decoding method.

### Effect of the Invention

According to the present invention, in the encoding or decoding of multiview images or multiview videos, when a viewpoint-synthesized image is utilized as a predicted image, spatial predictive encoding of a corresponding prediction residual can be performed while preventing the relevant processing or memory access from becoming complex.

### BRIEF DESCRIPTION OF THE DRAWINGS

FIG. 1 is a block diagram that shows the structure of the image encoding apparatus according to an embodiment of the present invention.

FIG. 2 is a flowchart showing the operation of the image encoding apparatus 100 shown in FIG. 1.

FIG. 3 is a block diagram that shows the structure of the image decoding apparatus according to an embodiment of the present invention.

FIG. 4 is a flowchart showing the operation of the image decoding apparatus 200 shown in FIG. 3.

FIG. 5 is a block diagram that shows a hardware configuration of the image encoding apparatus 100 formed using a computer and a software program.

FIG. 6 is a block diagram that shows a hardware configuration of the image decoding apparatus 200 formed using a computer and a software program.

FIG. 7 is a schematic view showing the concept of disparity generated between cameras.

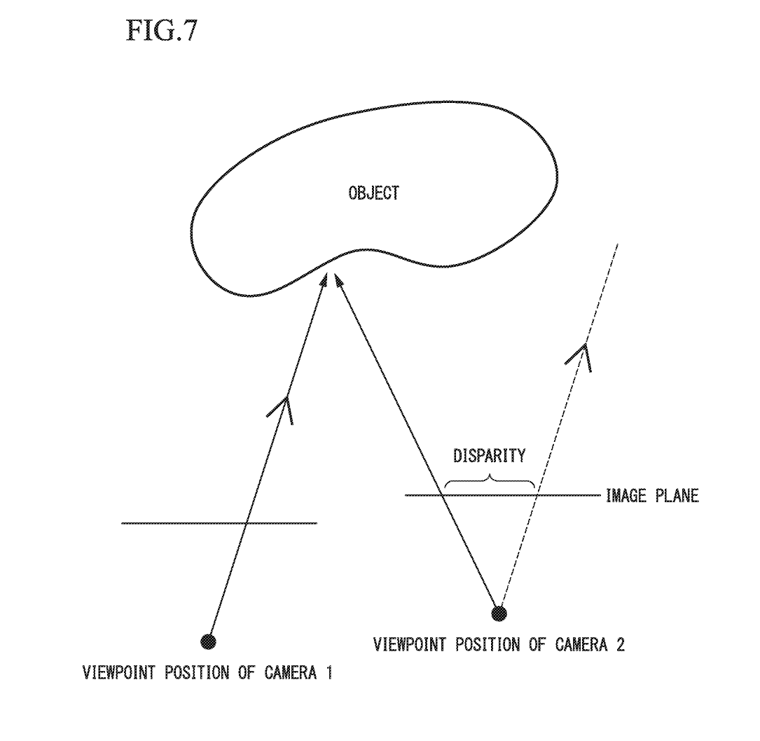

FIG. 8 is a schematic view showing the concept of the Epipolar geometry constraint.

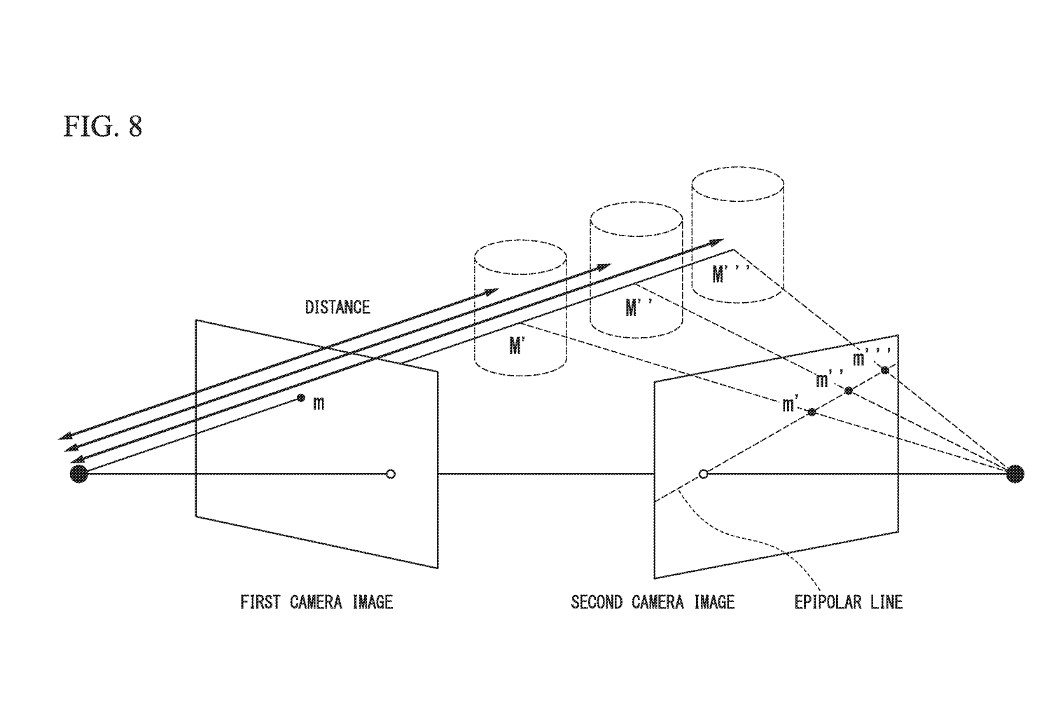

### MODE FOR CARRYING OUT THE INVENTION

Below, an image encoding apparatus and an image decoding apparatus as embodiments of the present invention will be explained with reference to the drawings.

The following explanation asserts that multiview images obtained from two viewpoints, which are a first viewpoint (called “viewpoint A”) and a second viewpoint (called “viewpoint B”), are encoded, where the image from the viewpoint B is encoded or decoded by utilizing the image of the viewpoint A as a reference viewpoint image.

Here, it is assumed that information required to obtain disparity from depth information is provided separately. Specifically, such information may be an external parameter that represents a positional relationship between the viewpoints A and B, or an internal parameter that represents information for projection by a camera or the like onto an image plane. However, information other than the above may be employed if required disparity can be obtained from the relevant depth information by using the employed information.

A detailed explanation about such camera parameters is found, for example, in the following document: Oliver Faugeras, “Three-Dimension Computer Vision”, MIT Press; BCTC/UFF-006.37 F259 1993, ISBN:0-262-06158-9. This document explains a parameter which indicates a positional relationship between a plurality of cameras, and a parameter which indicates information for the projection by a camera onto an image plane.

In the following explanation, information utilized to identify a position (coordinate values or an index which can be associated with the coordinate values) is added to an image, a video frame, or a depth map, where the information is interposed between square brackets “[ ]”, and such a format represents an image signal obtained by sampling that uses a pixel at the relevant position or a depth for the pixel.

It is also defined that addition of an index value, which can be associated with coordinate values or a block, and a vector represents coordinate values or a block obtained by shifting the original coordinate values or block by using the vector.

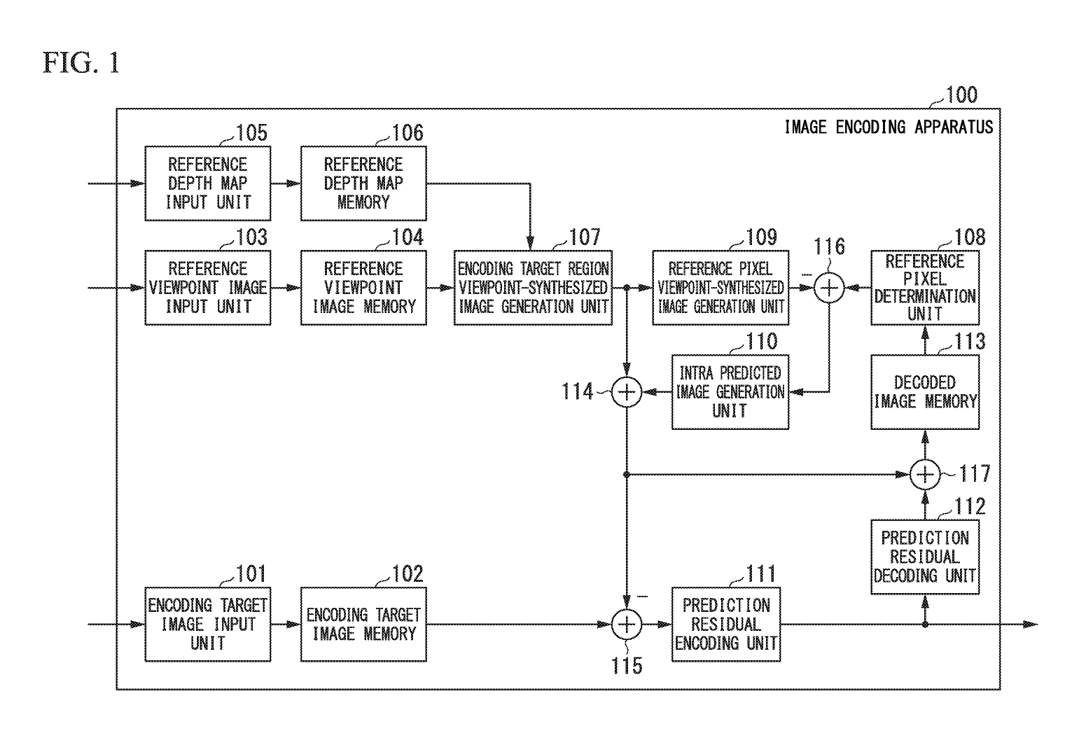

FIG. 1 is a block diagram that shows the structure of the image encoding apparatus according to the present embodiment.

As shown in FIG. 1, the image encoding apparatus 100 has an encoding target image input unit 101, an encoding target image memory 102, a reference viewpoint image input unit 103, a reference viewpoint image memory 104, a reference depth map input unit 105, a reference depth map memory 106, an encoding target region viewpoint-synthesized image generation unit 107, a reference pixel determination unit 108, a reference pixel viewpoint-synthesized image generation unit 109, an intra predicted image generation unit 110, a prediction residual encoding unit 111, a prediction residual decoding unit 112, a decoded image memory 113, and four adders 114, 115, 116, and 117.

The encoding target image input unit 101 inputs an image as an encoding target into the image encoding apparatus 100. Below, this image as the encoding target is called an “encoding target image”. Here, an image obtained from the viewpoint B is input. In addition, the viewpoint (here, the viewpoint B) from which the encoding target image is obtained is called an “encoding target viewpoint”.

The encoding target image memory 102 stores the input encoding target image.

The reference viewpoint image input unit 103 inputs an image, which is referred to when a viewpoint-synthesized image (disparity-compensated image) is generated, into the image encoding apparatus 100. Below, this input image is called a “reference viewpoint image”. Here, an image obtained from the viewpoint A is input.

The reference viewpoint image memory 104 stores the input reference viewpoint image.

The reference depth map input unit 105 inputs a depth map, which is referred to when the viewpoint-synthesized image is generated, into the image encoding apparatus 100. Although a depth map corresponding to the reference viewpoint image is input here, a depth map corresponding to another viewpoint may be input. Below, the input depth map is called a “reference depth map”.

Here, the depth map represents a three-dimensional position of an imaged object at each pixel of a target image and may be provided in any information manner if the three-dimensional position can be obtained by using information such as a camera parameter provided separately, or the like. For example, a distance from a camera to the object, coordinate values for an axis which is not parallel to the image plane, or the amount of disparity for another camera (e.g., camera at the viewpoint B) may be employed.

Since the amount of disparity is a target here, a disparity map that directly represents the amount of disparity may be used instead of the depth map.

In addition, the depth map is provided as a form of image here, another form may be employed if similar information can be obtained.

Below, the viewpoint corresponding to the reference depth map (here, the viewpoint A) is called a “reference depth viewpoint”.

The reference depth map memory 106 stores the input reference depth map.

The encoding target region viewpoint-synthesized image generation unit 107 uses the reference depth map to obtain a correspondence relationship between the pixels of the encoding target image and the pixels of the reference viewpoint image and generates a viewpoint-synthesized image for an encoding target region.

The reference pixel determination unit 108 determines a set of pixels which are referred to when the intra prediction is performed for the encoding target region. Below, the determined set of pixels are called “reference pixels”.

The reference pixel viewpoint-synthesized image generation unit 109 uses the viewpoint-synthesized image for the encoding target region to generate a viewpoint-synthesized image for the reference pixels.

The intra predicted image generation unit 110 utilizes a difference (output from the adder 116) between the viewpoint-synthesized image for the reference pixels and a decoded image for the reference pixels (output from the reference pixel determination unit 108) to generate an intra predicted image for a difference image between the encoding target image and the viewpoint-synthesized image in the encoding target region. Below, the intra predicted image for the difference image is called a “difference intra predicted image”.

The adder 114 adds the viewpoint-synthesized image and the difference intra predicted image.

The adder 115 computes a difference between the encoding target image and a signal output from the adder 114 and outputs a prediction residual.

The prediction residual encoding unit 111 encodes the prediction residual (output from the adder 115) for the encoding target image in the encoding target region.

The prediction residual decoding unit 112 decodes the encoded prediction residual.

The adder 117 adds the signal output from the adder 114 and the decoded prediction residual and outputs a decoded encoding target image.

The decoded image memory 113 stores the decoded encoding target image.

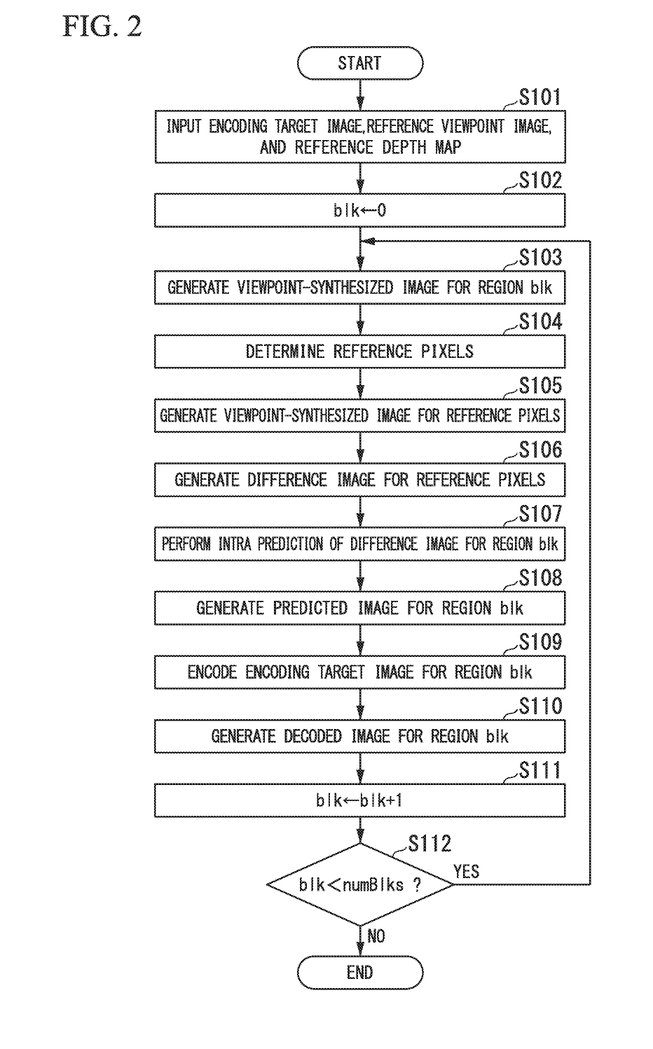

Next, the operation of the image encoding apparatus 100 shown in FIG. 1 will be explained with reference to FIG. 2. FIG. 2 is a flowchart showing the operation of the image encoding apparatus 100 shown in FIG. 1.

First, the encoding target image input unit 101 inputs an encoding target image Org into the image encoding apparatus 100 and stores the input image in the encoding target image memory 102. The reference viewpoint image input unit 103 inputs a reference viewpoint image into the image encoding apparatus 100 and stores the input image in the reference viewpoint image memory 104. The reference depth map input unit 105 inputs a reference depth map into the image encoding apparatus 100 and stores the input depth map in the reference depth map memory 106 (see step S101).

Here, the reference viewpoint image and the reference depth map input in step S101 are identical to those (which may be decoded information of already-encoded information) obtained in a corresponding decoding apparatus. This is because generation of encoding noise (e.g., drift) can be suppressed by using the completely same information as information which can be obtained in the decoding apparatus. However, if generation of such encoding noise is acceptable, information which can be obtained only in the encoding apparatus may be input (e.g., information which has not yet been encoded).

As for the reference depth map, instead of a depth map which has already been encoded and is decoded, a depth map estimated by applying stereo matching or the like to multiview images which are decoded for a plurality of cameras, or a depth map estimated by using a decoded disparity or motion vector may be utilized as identical information which can be obtained in the decoding apparatus.

In addition, if there is a separate image encoding apparatus or the like with respect to another viewpoint, by which it is possible to obtain the relevant image or depth map for a required region on each required occasion, then it is unnecessary for the image encoding apparatus 100 to have memory units for the relevant image or depth map, and information required for each region (explained below) may be input into the image encoding apparatus 100 at an appropriate timing.

After the input of the encoding target image, the reference viewpoint image, and the reference depth map is completed, the encoding target image is divided into regions having a predetermined size and predictive encoding of the image signal of the encoding target image is performed for each divided region (see steps S102 to S112).

More specifically, given “blk” for an encoding target region index and “numBlks” for the total number of encoding target regions in the encoding target image, blk is initialized to be 0 (see step S102), and then the following process (from step S103 to step S110) is repeated while adding 1 to blk each time (see step S111) until blk reaches numBlks (see step S112).

In ordinary encoding, the encoding target image is divided into processing unit blocks called “macroblocks” each being formed as 16×16 pixels. However, it may be divided into blocks having another block size if the condition is the same as that in the decoding apparatus. In addition, the divided regions may have individual sizes.

In the process repeated for each encoding target region, first, the encoding target region viewpoint-synthesized image generation unit 107 generates a viewpoint-synthesized image Syn for the encoding target region blk (see step S103).

This process may by performed in any method if an image for the encoding target region blk is synthesized by using the reference viewpoint image and the reference depth map. For example, methods disclosed in Non-Patent Document 2 or the following document may be employed: L. Zhang, G. Tech, K. Wegner, and S. Yea, “Test Model 7 of 3D-HEVC and MV-HEVC”, Joint Collaborative Team on 3D Video Coding Extension Development of ITU-T SG 16 WP 3 and ISO/IEC JTC 1/SC 29/WG 11, Doc. JCT3V-G1005, San Jose, US, January 2014.

Next, the reference pixel determination unit 108 determines reference pixels Ref which are selected from a decoded image Dec (stored in the decoded image memory 113 for an already-encoded region) and used when the intra prediction for the encoding target region blk is performed (see step S104). Although any type of the intra prediction may be performed, the reference pixels are determined based on the method of the intra prediction.

For example, when the intra prediction according to the video compression coding standard H. 265 (so-called “HEVC”) disclosed in Non-Patent Document 1 is employed, if the encoding target region has a size of N×N pixels (N is a natural number of 2 or greater), the reference pixels are set to 4N+1 pixels in a neighboring region of the encoding target region blk.

More specifically, if the position of the upper-left pixel in the encoding target region blk is represented by [x,y]=[0,0], the reference pixels are set to the pixels at a location of “x=−1 and −1≦y≦2N−1” or “−1≦x≦2N−1 and y=−1”. In accordance with whether or not a decoded image for each position in the location is included in the decoded image memory, the reference pixels are prepared as follows:

(1) When the decoded image is obtained at every pixel position of the reference pixels, the following substitution is performed: Ref[x,y]=Dec[x,y].
(2) When no decoded image is obtained at every pixel position of the reference pixels, the following substitution is performed Ref[x,y]=1<<(BitDepth−1), where “<<” denotes a left bit-shift operation, and BitDepth denotes a bit depth of a relevant pixel value of the encoding target image.
(3) In other cases, the pixel positions of “4N+1 reference pixels” are scanned in order starting from [−1, 2N−1] through [−1, −1] to [2N−1, −1] so as to obtain a position [x₀,y₀] at which the decoded image first exists.

Then the following substitution is performed: Ref[−1, 2N−1]=Dec[x₀,y₀].

Scanning is performed in order starting from [−1, 2N−2] to [−1, −1]. If the decoded image is obtained at a target pixel position [−1, y], the following substitution is performed: Ref[−1, y]=Dec[−1, y]. If no decoded image is obtained at the target pixel position [−1, y], the following substitution is performed: Ref[−1, y]=Ref[−1, y+1].

Scanning is performed in order starting from [0, −1] to [2N−1, −1]. If the decoded image is obtained at a target pixel position [x, −1], the following substitution is performed: Ref[x, −1]=Dec[x, −1]. If no decoded image is obtained at the target pixel position [x, −1], the following substitution is performed: Ref[x, −1]=Ref[x−1, −1].

Here, in directional prediction as one type of the intra prediction of HEVC, the reference pixels determined as explained above are not directly used. Instead, after the reference pixels are updated by a process called “thinning copy”, the predicted image is generated by using the updated reference image. Although the reference pixels before executing the thinning copy are employed in the above explanation, the thinning copy may be performed and the updated reference pixels are newly determined to be the reference pixels. A detailed explanation for the thinning copy is disclosed in Non-Patent Document 1 (see Section 8.4.4.2.6, pp. 109-111).

After the determination of the reference pixels is completed, the reference pixel viewpoint-synthesized image generation unit 109 generates a viewpoint-synthesized image Syn′ for the reference pixels (see step S105). This process may by performed in any method if an identical process can be performed by the corresponding decoding apparatus and the generation is performed by using the viewpoint-synthesized image for the encoding target region blk.

For example, for each target pixel position of the reference pixels, the viewpoint-synthesized image for a pixel (in the encoding target region blk) at the shortest distance from the target pixel of the reference pixels may be assigned to this target pixel. In case of the reference pixels in the above-described HEVC, the viewpoint-synthesized image generated for the reference pixels is represented by the following formulas (1) to (5):

Syn′[−1,−1]=Syn[0,0] (1)

Syn′[−1,y]=Syn[0,y] (0≦y≦N−1) (2)

Syn′[−1,y]=Syn[0,N−1] (N≦y≦2N−1) (3)

Syn′[x,−1]=Syn[x,0] (0≦x≦N−1) (4)

Syn′[x,−1]=Syn[N−1,0] (0≦x≦2N−1) (5)

In another method, for each target pixel position of the reference pixels, (i) if the target pixel is adjacent to the encoding target region, the viewpoint-synthesized image at the relevant adjacent pixel (in the encoding target region) may be assigned to this target pixel, and (i) if the target pixel is not adjacent to the encoding target region, the viewpoint-synthesized image for a pixel (in the encoding target region) at the shortest distance from the target pixel in a 45-degree oblique direction may be assigned to this target pixel.

In the reference pixels in the above-described HEVC, the viewpoint-synthesized images generated for the reference pixels are represented by the following formulas (6) to (10) for this case:

Syn′[−1,−1]=Syn[0,0] (6)

Syn′[−1,y]=Syn[0,y] (0≦y≦N−1) (7)

Syn′[−1,y]=Syn[y−N,N−1] (N≦y≦2N−1) (8)

Syn′[x,−1]=Syn[x,0] (0≦x≦N−1) (9)

Syn′[x,−1]=Syn[N−1,x−N] (N≦x≦2N−1) (10)

Here, an angle other than “45-degree oblique” may be employed, and an angle based on the prediction direction for the utilized intra prediction may be used. For example, the viewpoint-synthesized image at a pixel (in the encoding target region) at the shortest distance from the target pixel in the prediction direction for the intra prediction may be assigned to the target pixel.

In another method, a viewpoint-synthesized image for the encoding target region may be analyzed to perform an extrapolation process so as to generate the target viewpoint-synthesized image, where any algorithm may be employed for the extrapolation. For example, extrapolation which utilizes the prediction direction used in the intra prediction may be performed, or the employed extrapolation may not relate to the prediction direction used in the intra prediction and may consider the direction of a texture of the viewpoint-synthesized image for the encoding target region.

In the above, regardless of the method of the intra prediction, the viewpoint-synthesized image is generated for every pixel which may be referred to in the intra prediction. However, the method of the intra prediction may be determined in advance, and based on this method, the viewpoint-synthesized image may be generated for only the pixels which are actually referred to.

If the reference pixels are updated by means of the thinning copy using neighboring pixels as in the intra directional prediction of the HEVC, the viewpoint-synthesized image for the updated position may be directly generated. Additionally, similar to the case of updating the reference pixels, after the viewpoint-synthesized image for the pre-updated reference pixels is generated, the viewpoint-synthesized image corresponding to the updated reference pixel positions may be generated by updating the viewpoint-synthesized image for the reference pixels by a method similar to the method of updating the reference pixels.

After the generation of the viewpoint-synthesized image for the reference pixels is completed, the adder 116 generates a difference between a signal output from the reference pixel viewpoint-synthesized image generation unit 109 and a signal output from the reference pixel determination unit 108 (i.e., a difference image VSRes for the reference pixels) according to the following formula (11) (see step S106).

Although Ref and Syn are evenly treated in the relevant subtraction, a weighted subtraction may be performed. In such a case, the same weight should be utilized between the encoding and decoding apparatuses.

VSRes[x,y]=Ref[x,y]−Syn′[x,y] (11)

Next, the intra predicted image generation unit 110 generates a difference intra predicted image RPred for the encoding target region blk by using the difference image for the reference pixels (see step S107). Any intra prediction method may be employed if the predicted image is generated by using the reference pixels.

After the difference intra predicted image is obtained, a predicted image Pred for the encoding target image in the encoding target region blk is generated by computing the sum of the viewpoint-synthesized image and the difference intra predicted image for each pixel by using the adder 114, as shown by the following formula (12) (see step S108):

Pred[blk]=Syn[blk]+RPred[blk] (12)

In the above, the result of the addition of the viewpoint-synthesized image and the difference intra predicted image is directly determined to be the predicted image. However, for each pixel, clipping within the value range of the pixels of the encoding target image may be applied to the result of the addition, and the clipped result may be determined to be the predicted image.

Furthermore, although Syn and RPred are evenly treated in the relevant addition, a weighted addition may be performed. In such a case, the same weight should be utilized between the encoding and decoding apparatuses.

In addition, such a weight may be determined according to a weight utilized when the difference image for the reference pixels is generated. For example, the rate for Syn when the difference image for the reference pixels is generated may be identical to the rate for Syn in Formula (12).

After the predicted image is obtained, the adder 115 computes a difference (i.e., prediction residual) between a signal output from the adder 114 and the encoding target image stored in the encoding target image memory 102. Then the prediction residual encoding unit 111 encodes the prediction residual which is the difference between the encoding target image and the predicted image (see step S109). A bit stream obtained by this encoding is a signal output from the image encoding apparatus 100.

The above encoding may be performed by any method. In generally known encoding such as MPEG-2, H.264/AVC, or HEVC, the above difference (residual) is sequentially subjected to frequency transformation such as DCT, quantization, binarization, and entropy encoding.

Next, the prediction residual decoding unit 112 decodes the prediction residual Res, and adds this prediction residual to the predicted image Pred (as shown in Formula (13)) by using the adder 117, so as to generate a decoded image Dec (see step S110).

Dec[blk]=Pred[blk]+Res[blk] (13)

After the addition of the predicted image and the prediction residual, clipping within the value range of the relevant pixel values may be performed.

The obtained decoded image is stored in the decoded image memory 113 so as to be used in the prediction for another encoding region.

For the decoding of the prediction residual, a method corresponding to the method utilized in the encoding is used. For example, for generally known encoding such as MPEG-2, H.264/AVC, or HEVC, the relevant bit stream is sequentially subjected to entropy decoding, inverse binarization, inverse quantization, and frequency inverse transformation such as IDCT.

Here, the decoding is performed from a bit stream. However, the decoding process may be performed in a simplified decoding manner by receiving relevant data immediately before the process in the encoding apparatus becomes lossless. That is, in the above-described example, the decoding process may be performed by (i) receiving a value after performing the quantization in the encoding and (ii) sequentially applying the inverse quantization and the frequency inverse transformation to the quantized value.

In addition, the image encoding apparatus 100 outputs a bit stream corresponding to an image signal. That is, a parameter set or a header which represents information such as the image size or the like is added to the bit stream (output from the image encoding apparatus 100) separately as needed.

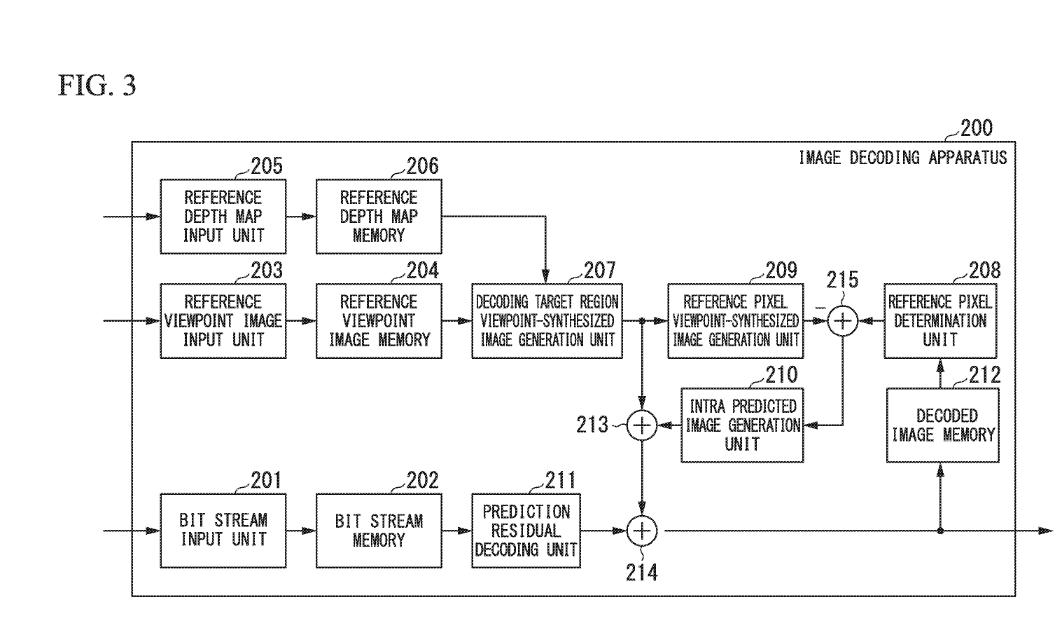

Below, an image decoding apparatus of the present embodiment will be explained. FIG. 3 is a block diagram that shows the structure of the image decoding apparatus in the present embodiment.

As shown in FIG. 3, the image decoding apparatus 200 includes a bit stream input unit 201, a bit stream memory 202, a reference viewpoint image input unit 203, a reference viewpoint image memory 204, a reference depth map input unit 205, a reference depth map memory 206, a decoding target region viewpoint-synthesized image generation unit 207, a reference pixel determination unit 208, a reference pixel viewpoint-synthesized image generation unit 209, an intra predicted image generation unit 210, a prediction residual decoding unit 211, a decoded image memory 212, and three adders 213, 214, and 215.

The bit stream input unit 201 inputs a bit stream of an image as a decoding target into the image decoding apparatus 200. Below, this image as the decoding target is called a “decoding target image”. Here, an image obtained from the viewpoint B is input. In addition, the viewpoint (here, the viewpoint B) from which the decoding target image is obtained is called a “decoding target viewpoint”.

The bit stream memory 202 stores the input bit stream for the decoding target image.

The reference viewpoint image input unit 203 inputs an image, which is referred to when a viewpoint-synthesized image (disparity-compensated image) is generated, into the image decoding apparatus 200. Below, this input image is called a “reference viewpoint image”. Here, an image obtained from the viewpoint A is input.

The reference viewpoint image memory 204 stores the input reference viewpoint image.

The reference depth map input unit 205 inputs a depth map, which is referred to when the viewpoint-synthesized image is generated, into the image decoding apparatus 200. Although a depth map corresponding to the reference viewpoint image is input here, a depth map corresponding to another viewpoint may be input. Below, the input depth map is called a “reference depth map”.

Here, the depth map represents a three-dimensional position of an imaged object at each pixel of a target image and may be provided in any information manner if the three-dimensional position can be obtained by using information such as a camera parameter provided separately, or the like. For example, a distance from a camera to the object, coordinate values for an axis which is not parallel to the image plane, or the amount of disparity for another camera (e.g., camera at the viewpoint B) may be employed.

Since the amount of disparity is a target here, a disparity map that directly represents the amount of disparity may be used instead of the depth map.

In addition, the depth map is provided as a form of image, another form may be employed if similar information can be obtained.

Below, the viewpoint corresponding to the reference depth map (here, the viewpoint A) is called a “reference depth viewpoint”.

The reference depth map memory 206 stores the input reference depth map.

The decoding target region viewpoint-synthesized image generation unit 207 uses the reference depth map to obtain a correspondence relationship between the pixels of the decoding target image and the pixels of the reference viewpoint image and generates a viewpoint-synthesized image for a decoding target region.

The reference pixel determination unit 208 determines a set of pixels which are referred to when the intra prediction is performed for the decoding target region. Below, the determined set of pixels are called “reference pixels”.

The reference pixel viewpoint-synthesized image generation unit 209 uses the viewpoint-synthesized image for the decoding target region to generate a viewpoint-synthesized image for the reference pixels.

For the reference pixels, the adder 215 outputs a difference image between a decoded image and the viewpoint-synthesized image.

The intra predicted image generation unit 210 utilizes this difference image between the decoded image and the viewpoint-synthesized image for the reference pixels to generate an intra predicted image for a difference image between the decoding target image and the viewpoint-synthesized image in the relevant decoding target region. Below, the intra predicted image for the difference image is called a “difference intra predicted image”.

The prediction residual decoding unit 211 decodes, from the bit stream, a prediction residual for the decoding target image of the decoding target region.

The adder 213 adds the viewpoint-synthesized image and the difference intra predicted image for the decoding target region and outputs the sum thereof.

The adder 214 adds a signal output from the adder 213 and the decoded prediction residual and outputs the result of the addition.

The decoded image memory 212 stores the decoded decoding target image.

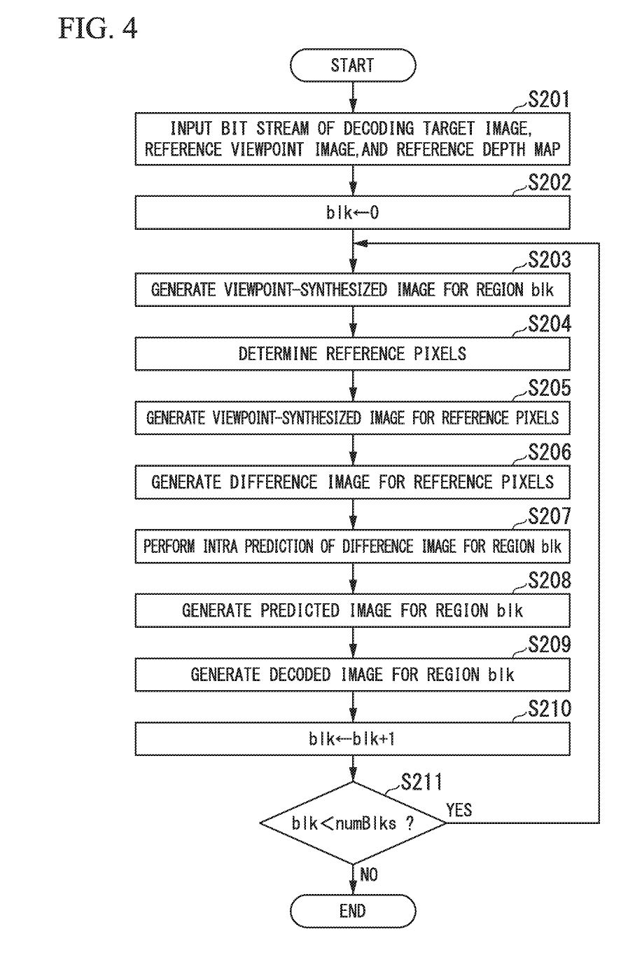

Next, the operation of the image decoding apparatus 200 shown in FIG. 3 will be explained with reference to FIG. 4. FIG. 4 is a flowchart showing the operation of the image decoding apparatus 200 shown in FIG. 3.

First, the bit stream input unit 201 inputs a bit stream as a result of the encoding of the decoding target image into the image decoding apparatus 200 and stores the input bit stream in the bit stream memory 202. The reference viewpoint image input unit 203 inputs a reference viewpoint image into the image decoding apparatus 200 and stores the input image in the reference viewpoint image memory 204. The reference depth map input unit 205 inputs a reference depth map into the image decoding apparatus 200 and stores the input depth map in the reference depth map memory 206 (see step S201).

Here, the reference viewpoint image and the reference depth map input in step S201 are identical to those used in the encoding apparatus. This is because generation of encoding noise (e.g., drift) can be suppressed by using the completely same information as information which can be obtained in the image encoding apparatus. However, if generation of such encoding noise is acceptable, information which differs from that used in the encoding apparatus may be input.

As for the reference depth map, instead of a depth map which is decoded separately, a depth map estimated by applying stereo matching or the like to multiview images which are decoded for a plurality of cameras, or a depth map estimated by using a decoded disparity or motion vector may be utilized.

In addition, if there is a separate image decoding apparatus or the like with respect to another viewpoint, by which it is possible to obtain the relevant image or depth map for a required region on each required occasion, then it is unnecessary for the image decoding apparatus 200 to have memories for the relevant image or depth map, and information required for each region (explained below) may be input into the image decoding apparatus 200 at an appropriate timing.

After the input of the bit stream, the reference viewpoint image, and the reference depth map is completed, the decoding target image is divided into regions having a predetermined size, and for each divided region, the image signal of the decoding target image is decoded (see steps S202 to S211).

More specifically, given “blk” for a decoding target region index and “numBlks” for the total number of decoding target regions in the decoding target image, blk is initialized to be 0 (see step S202), and then the following process (from step S203 to step S209) is repeated while adding 1 to blk each time (see step S210) until blk reaches numBlks (see step S211).

In ordinary decoding, the decoding target image is divided into processing unit blocks called “macroblocks” each being formed as 16×16 pixels. However, it may be divided into blocks having another block size if the condition is the same as that in the encoding apparatus. In addition, the divided regions may have individual sizes.

In the process repeated for each decoding target region, first, the decoding target region viewpoint-synthesized image generation unit 207 generates a viewpoint-synthesized image Syn for the decoding target region blk (see step S203).

This process is identical to that performed in step S103 in the above-described encoding. Such an identical process is required so as to suppress generation of encoding noise (e.g., drift). However, if generation of such encoding noise is acceptable, a method other than that used in the encoding apparatus may be used.

Next, the reference pixel determination unit 208 determines, based on a decoded image Dec (stored in the decoded image memory 212 for an already-decoded region), reference pixels Ref used when the intra prediction for the decoding target region blk is performed (see step S204). This process is identical to that performed in step S104 in the above-described encoding.

Any method of intra prediction may be employed if the method is identical to that employed in the encoding apparatus. The reference pixels are determined based on the method of the intra prediction.

After the determination of the reference pixels is completed, the reference pixel viewpoint-synthesized image generation unit 209 generates a viewpoint-synthesized image Syn′ for the reference pixels (see step S205). This process is identical to that performed in step S105 in the above-described encoding, and any method may be employed if the method is identical to that employed in the encoding apparatus.

After the generation of the viewpoint-synthesized image for the reference pixels is completed, the adder 215 generates a difference image VSRes for the reference pixels (see step S206). After that, the intra predicted image generation unit 210 generates a difference intra predicted image RPred by using the generated difference image for the reference pixels (see step S207).

These processes are identical to those performed in steps S106 and S107 in the above-described encoding, and any methods may be employed if the methods are identical to those employed in the encoding apparatus.

After the difference intra predicted image is obtained, the adder 213 generates a predicted image Pred for the decoding target image in the decoding target region blk (see step S208). This process is identical to that performed in step S108 in the above-described encoding.

After the predicted image is obtained, the prediction residual decoding unit 211 decodes the prediction residual for the decoding target region blk from the bit stream and generates a decoded image Dec by adding the predicted image and the prediction residual by using the adder 214 (see step S209).

For the decoding, a method corresponding to that used in the encoding apparatus is employed. For example, when generally known encoding such as MPEG-2, H.264/AVC, or HEVC is employed, the relevant bit stream is sequentially subjected to entropy decoding, inverse binarization, inverse quantization, and frequency inverse transformation such as IDCT so as to perform the decoding.

The obtained decoded image is a signal output from the image decoding apparatus 200 and stored in the decoded image memory 212 so as to be used in the prediction for another decoding target region.

In addition, a bit stream corresponding to an image signal is input into the image decoding apparatus 200. That is, a parameter set or a header which represents information such as the image size or the like is interpreted outside the image decoding apparatus 200 and information required for the decoding is communicated to the image decoding apparatus 200 as needed.

In addition, although the above explanation employs an operation of encoding or decoding the entire image, the operation may be applied to only part of the image. In this case, whether the operation is to be applied or not may be determined and a flag that indicates a result of the determination may be encoded or decoded, or the result may be designated by using an arbitrary device. For example, whether the operation is to be applied or not may be represented as one of the modes that indicate methods of generating a predicted image for each region.

Additionally, the encoding or decoding may be performed while selecting one of intra prediction methods for each region. In such a case, the intra prediction method employed for each region should be the same between the encoding and decoding apparatuses.

This condition may be implemented by any method. For example, the employed intra prediction method may be encoded as mode information which is included in the bit stream to be communicated to the decoding apparatus. In this case, in the decoding, information which indicates the intra prediction method employed for each region is decoded from the bit stream, and the generation of the difference intra predicted image should be performed based on the decoded information.

In order that the same intra prediction method as that of the encoding apparatus is used without encoding such information, an identical estimation process may be performed between the encoding and decoding apparatuses by using a position on a frame or already-decoded information.

In the above-explained operation, one frame is encoded and then decoded. However, the operation can be applied to video coding by repeating the operation for a plurality of frames. Furthermore, the operation can be applied to part of frames or part of blocks of a video.

In addition, although the structures and operations of the image encoding apparatus and the image decoding apparatus are explained in the above explanation, the image encoding method and the image decoding method of the present invention can be implemented by operations corresponding to the operations of the individual units in the image encoding apparatus and the image decoding apparatus.

Additionally, in the above explanation, the reference depth map is a depth map for an image obtained by a camera other than the encoding target camera or the decoding target camera. However, the reference depth map may be a depth map for an image obtained by the encoding target camera or the decoding target camera at a time other than the time when the encoding target image or the decoding target image was obtained.

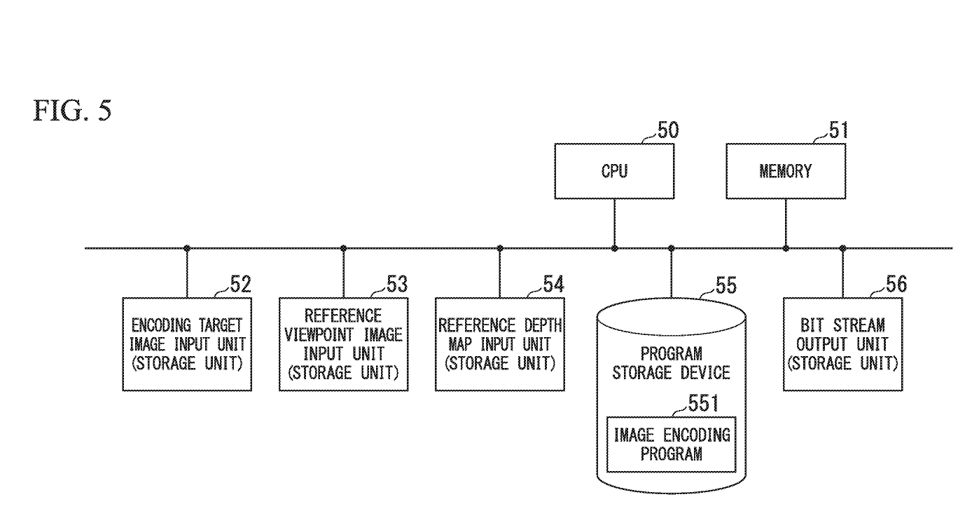

FIG. 5 is a block diagram that shows a hardware configuration of the above-described image encoding apparatus 100 formed using a computer and a software program.

In the system of FIG. 5, the following elements are connected via a bus:

(i) a CPU 50 that executes the relevant program;
(ii) a memory 51 (e.g., RAM) that stores the program and data accessed by the CPU 50;
(iii) an encoding target image input unit 52 that makes an image signal of an encoding target from a camera or the like input into the image encoding apparatus and may be a storage unit (e.g., disk device) which stores the image signal;
(iv) a reference viewpoint image input unit 53 that makes an image signal from a reference viewpoint obtained from a camera or the like input into the image encoding apparatus and may be a storage unit (e.g., disk device) which stores the image signal;
(v) a reference depth map input unit 54 that inputs a depth map from a depth camera (utilized to obtain depth information) or the like into the image encoding apparatus, where the depth map relates to a camera by which the same scene as that obtained from the encoding target viewpoint and also in the reference viewpoint image was photographed, and the unit 54 may be a storage unit (e.g., disk device) which stores the depth map;
(vi) a program storage device 55 that stores an image encoding program 551 which is a software program for making the CPU 50 execute the image encoding operation; and
(vii) a bit stream output unit 56 that outputs a bit stream, which is generated by the CPU 50 which executes the image encoding program 551 loaded on the memory 51, via a network or the like, where the output unit 56 may be a storage unit (e.g., disk device) which stores the bit stream.

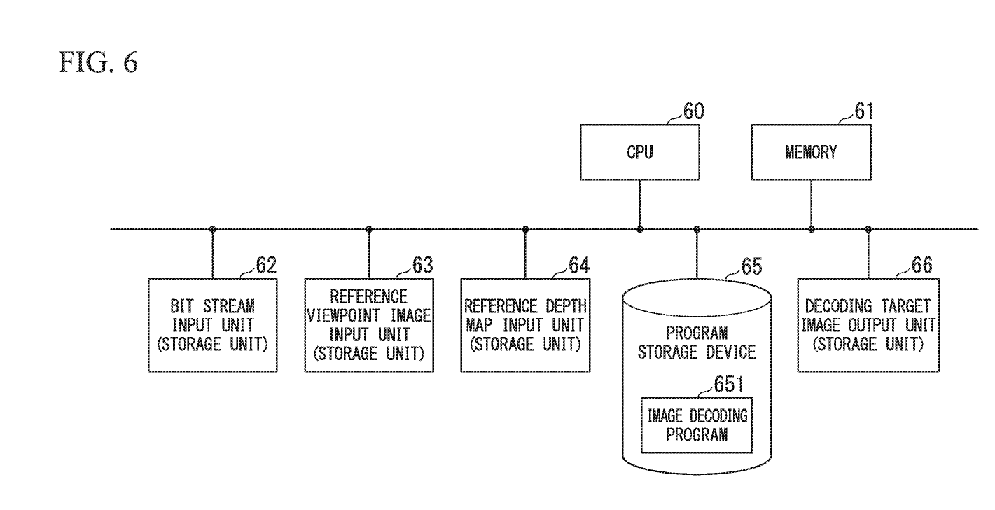

FIG. 6 is a block diagram that shows a hardware configuration of the above-described image decoding apparatus 200 formed using a computer and a software program.

In the system of FIG. 6, the following elements are connected via a bus:

(i) a CPU 60 that executes the relevant program;
(ii) a memory 61 (e.g. RAM) that stores the program and data accessed by the CPU 60;
(iii) a bit stream input unit 62 that makes a bit stream encoded by the image encoding apparatus according to the present method into the image decoding apparatus and may be a storage unit (e.g., disk device) which stores an image signal;
(iv) a reference viewpoint image input unit 63 that makes an image signal from a reference viewpoint obtained from a camera or the like input into the image decoding apparatus and may be a storage unit (e.g., disk device) which stores the image signal;
(v) a reference depth map input unit 64 that inputs a depth map from a depth camera or the like into the image decoding apparatus, where the depth map relates to a camera by which the same scene as that in the decoding target image and also in the reference viewpoint image was photographed, and the unit 64 may be a storage unit (e.g., disk device) which stores depth information;
(vi) a program storage device 65 that stores an image decoding program 651 which is a software program for making the CPU 60 execute the video decoding operation; and
(vii) a decoding target image output unit 66 that outputs a decoding target image, which is obtained by the CPU 60 which executes the image decoding program 651 loaded on the memory 61 so as to decode the bit stream, to a reproduction apparatus or the like, where the output unit 66 may be a storage unit (e.g., disk device) which stores the image signal.

As described above, when a viewpoint-synthesized image is utilized as a predicted image and its prediction residual is subjected to spatial predictive encoding, a viewpoint-synthesized image for a reference image with respect to the prediction residual is estimated from a viewpoint-synthesized image for the prediction target region. Therefore, the disparity-compensated prediction operation required to generate the viewpoint-synthesized image is not complex, and thus multiview images or videos can be encoded and decoded with less processing quantity.

The image encoding apparatus 100 and the image decoding apparatus 200 in the above embodiment may be implemented by utilizing a computer. In this case, a program for executing the relevant functions may be stored in a computer-readable storage medium, and the program stored in the storage medium may be loaded and executed on a computer system, so as to implement the relevant apparatus.

Here, the computer system has hardware resources which may include an OS and peripheral devices.

The above computer-readable storage medium is a storage device, for example, a portable medium such as a flexible disk, a magneto optical disk, a ROM, or a CD-ROM, or a memory device such as a hard disk built in a computer system.

The computer-readable storage medium may also include a device for temporarily storing the program, for example, (i) a device for dynamically storing the program for a short time, such as a communication line used when transmitting the program via a network (e.g., the Internet) or a communication line (e.g., a telephone line), or (ii) a volatile memory in a computer system which functions as a server or client in such a transmission.

In addition, the program may execute a part of the above-explained functions. The program may also be a “differential” program so that the above-described functions can be executed by a combination of the differential program and an existing program which has already been stored in the relevant computer system. Furthermore, the program may be implemented by utilizing a hardware devise such as a PLD (programmable logic device) or an FPGA (field programmable gate array).

While the embodiments of the present invention have been described and shown above, it should be understood that these are exemplary embodiments of the invention and are not to be considered as limiting. Additions, omissions, substitutions, and other modifications can be made without departing from the technical concept and scope of the present invention.

### INDUSTRIAL APPLICABILITY

The present invention can be applied to a purpose which essentially requires the following: when predictive encoding using a viewpoint-synthesized image for an encoding (or decoding) target image is performed by using (i) an image obtained from a position other than that of a camera which obtained the encoding (or decoding) target image and (ii) a depth map for an object in the obtained image, a difference image between the encoding (or decoding) target image and the viewpoint-synthesized image is spatially predicted while suppressing an increase or complication in the memory access or relevant processing accompanied with an increase of a region which requires the viewpoint-synthesized image, and thereby implementing a high level of encoding efficiency.

### REFERENCE SYMBOLS

100 image encoding apparatus
101 encoding target image input unit
102 encoding target image memory
103 reference viewpoint image input unit
104 reference viewpoint image memory
105 reference depth map input unit
106 reference depth map memory
107 encoding target region viewpoint-synthesized image generation unit
108 reference pixel determination unit
109 reference pixel viewpoint-synthesized image generation unit
110 intra predicted image generation unit
111 prediction residual encoding unit
112 prediction residual decoding unit
113 decoded image memory
114, 115, 116, 117 adder
200 image decoding apparatus
201 bit stream input unit
202 bit stream memory
203 reference viewpoint image input unit
204 reference viewpoint image memory
205 reference depth map input unit
206 reference depth map memory
207 decoding target region viewpoint-synthesized image generation unit
208 reference pixel determination unit
209 reference pixel viewpoint-synthesized image generation unit
210 intra predicted image generation unit
211 prediction residual decoding unit
212 decoded image memory
213, 214, 215 adder

1. An image encoding apparatus that encodes multiview images from different viewpoints, where each of encoding target regions obtained by dividing an encoding target image is encoded while an already-encoded reference viewpoint image from a viewpoint other than that of the encoding target image and a reference depth map for an object imaged in the reference viewpoint image are used to predict an image between different viewpoints, the apparatus comprising:
an encoding target region viewpoint-synthesized image generation device that generates a first viewpoint-synthesized image for the encoding target region by using the reference viewpoint image and the reference depth map;
a reference pixel determination device that determines a set of already-encoded pixels, which are referred to in intra prediction of the encoding target region, to be reference pixels;
a reference pixel viewpoint-synthesized image generation device that generates a second viewpoint-synthesized image for the reference pixels by using the first viewpoint-synthesized image; and
an intra predicted image generation device that generates an intra predicted image for the encoding target region by using a decoded image for the reference pixels and the second viewpoint-synthesized image.

2. The image encoding apparatus in accordance with claim 1, wherein the intra predicted image generation device generates:
a difference intra predicted image which is an intra predicted image for a difference image between the encoding target image of the encoding target region and the first viewpoint-synthesized image; and
the intra predicted image for the encoding target region by using the difference intra predicted image and the first viewpoint-synthesized image.

3. The image encoding apparatus in accordance with claim 1, further comprising:
an intra prediction method setting device that sets an intra prediction method applied to the encoding target region,
wherein the reference pixel determination device determines a set of already-encoded pixels, which are referred to when the intra prediction method is used, to be the reference pixels; and
the intra predicted image generation device generates the intra predicted image based on the intra prediction method.

4. The image encoding apparatus in accordance with claim 3, wherein the reference pixel viewpoint-synthesized image generation device generates the second viewpoint-synthesized image based on the intra prediction method.

5. The image encoding apparatus in accordance with claim 1, wherein the reference pixel viewpoint-synthesized image generation device generates the second viewpoint-synthesized image by performing an extrapolation from the first viewpoint-synthesized image.

6. The image encoding apparatus in accordance with claim 5, wherein the reference pixel viewpoint-synthesized image generation device generates the second viewpoint-synthesized image by using a set of pixels of the first viewpoint-synthesized image, which corresponds to a set of pixels which belong to the encoding target region and are adjacent to pixels outside the encoding target region.

7. An image decoding apparatus that decodes a decoding target image from encoded data for multiview images from different viewpoints, where each of decoding target regions obtained by dividing the decoding target image is decoded while an already-decoded reference viewpoint image from a viewpoint other than that of the decoding target image and a reference depth map for an object imaged in the reference viewpoint image are used to predict an image between different viewpoints, the apparatus comprising:
a decoding target region viewpoint-synthesized image generation device that generates a first viewpoint-synthesized image for the decoding target region by using the reference viewpoint image and the reference depth map;
a reference pixel determination device that determines a set of already-decoded pixels, which are referred to in intra prediction of the decoding target region, to be reference pixels;
a reference pixel viewpoint-synthesized image generation device that generates a second viewpoint-synthesized image for the reference pixels by using the first viewpoint-synthesized image; and
an intra predicted image generation device that generates an intra predicted image for the decoding target region by using a decoded image for the reference pixels and the second viewpoint-synthesized image.

8. The image decoding apparatus in accordance with claim 7, wherein the intra predicted image generation device generates:
a difference intra predicted image which is an intra predicted image for a difference image between the decoding target image of the decoding target region and the first viewpoint-synthesized image; and
the intra predicted image for the encoding target region by using the difference intra predicted image and the first viewpoint-synthesized image.

9. The image decoding apparatus in accordance with claim 7, further comprising:
an intra prediction method setting device that sets an intra prediction method applied to the decoding target region;
the reference pixel determination device determines a set of already-decoded pixels, which are referred to when the intra prediction method is used, to be the reference pixels; and
the intra predicted image generation device generates the intra predicted image based on the intra prediction method.

10. The image decoding apparatus in accordance with claim 9, wherein the reference pixel viewpoint-synthesized image generation device generates the second viewpoint-synthesized image based on the intra prediction method.

11. The image decoding apparatus in accordance with claim 7, wherein the reference pixel viewpoint-synthesized image generation device generates the second viewpoint-synthesized image by performing an extrapolation from the first viewpoint-synthesized image.

12. The image decoding apparatus in accordance with claim 11, wherein the reference pixel viewpoint-synthesized image generation device generates the second viewpoint-synthesized image by using a set of pixels of the first viewpoint-synthesized image, which corresponds to a set of pixels which belong to the decoding target region and are adjacent to pixels outside the decoding target region.

13. An image encoding method that encodes multiview images from different viewpoints, where each of encoding target regions obtained by dividing an encoding target image is encoded while an already-encoded reference viewpoint image from a viewpoint other than that of the encoding target image and a reference depth map for an object imaged in the reference viewpoint image are used to predict an image between different viewpoints, the method comprising:
an encoding target region viewpoint-synthesized image generation step that generates a first viewpoint-synthesized image for the encoding target region by using the reference viewpoint image and the reference depth map;
a reference pixel determination step that determines a set of already-encoded pixels, which are referred to in intra prediction of the encoding target region, to be reference pixels;
a reference pixel viewpoint-synthesized image generation step that generates a second viewpoint-synthesized image for the reference pixels by using the first viewpoint-synthesized image; and
an intra predicted image generation step that generates an intra predicted image for the encoding target region by using a decoded image for the reference pixels and the second viewpoint-synthesized image.

14. An image decoding method that decodes a decoding target image from encoded data for multiview images from different viewpoints, where each of decoding target regions obtained by dividing the decoding target image is decoded while an already-decoded reference viewpoint image from a viewpoint other than that of the decoding target image and a reference depth map for an object imaged in the reference viewpoint image are used to predict an image between different viewpoints, the method comprising:
a decoding target region viewpoint-synthesized image generation step that generates a first viewpoint-synthesized image for the decoding target region by using the reference viewpoint image and the reference depth map;
a reference pixel determination step that determines a set of already-decoded pixels, which are referred to in intra prediction of the decoding target region, to be reference pixels;
a reference pixel viewpoint-synthesized image generation step that generates a second viewpoint-synthesized image for the reference pixels by using the first viewpoint-synthesized image; and
an intra predicted image generation step that generates an intra predicted image for the decoding target region by using a decoded image for the reference pixels and the second viewpoint-synthesized image.

15. An image encoding program utilized to make a computer execute the image encoding method in accordance with claim 13.

16. An image decoding program utilized to make a computer execute the image decoding method in accordance with claim 14.
